(19) United States
(12) Patent Application Publication
(10) Pub. No.: US 2008/0243878 A1
(43) Pub. Date: Oct. 2, 2008

(54) Removal

(75) Inventors: Kristof de Spiegeleer, Knokke-Heist (BE); Nick Cremelie, Gent (BE); Koen D'Hondt, The Hague (NL); Bastiaan Stougie, Melle (BE); Mark Vertongen, Wetteren (BE)

Correspondence Address: MEYERTONS, HOOD, KIVLIN, KOWERT & GOETZEL, P.C., P.O. BOX 398, AUSTIN, TX, 78767-0398, US

(73) Assignee: Symantec Corporation

(21) Appl. No.: 11/731,572

(22) Filed: Mar. 29, 2007

(51) Int. Cl. G06F 17/30

(52) U.S. Cl. 707/100; 707/204; 707/E17.007; 707/E17.005

(57) ABSTRACT

There can be provided a system, method and apparatus to enable a data object to be removed from a single-instancing data object store in such a way as to ensure that only data objects to which all references have been removed are actually removed from the store. Thereby, consistency and reliability of storage can be maintained while allowing a data object which genuinely needs to be deleted to be removed from the store.

### FIELD

The present invention relates to removal, and in particular, but not exclusively to removal of data from a single instancing data archival and/or backup environment.

### BACKGROUND

In data archival and/or backup environments, there is often a need to store many data objects within an archival/backup system. Such data objects may need to be kept for a specific period of time, or until a certain matter has been completed. Sometimes a regulatory provision may require the keeping of all documents for a certain minimum time period. An example of such a regulatory requirement is the data retention requirement set out in the US Sarbanes-Oxley Act of 2002.

In some data archival and/or backup systems, files may be subjected to single instance processing, so as to prevent the system from wastefully storing multiple copies of the same document. Thus a single stored document in the archival/backup system number may have originated from a number of different sources at different times.

In some data archival and/or backup systems, large files are split into a number of equal sized units commonly known as segments. In this way, when data is appended to a file which has already been archived/backed-up, a later archival/backup operation need only create segments corresponding to the new data.

The present invention has been made, at least in part, in consideration of drawbacks and limitations of conventional systems.

### SUMMARY

Thus there can be provided a system, method and apparatus to enable a data object to be removed from a single-instancing data object store in such a way as to ensure that only data objects to which all references have been removed are actually removed from the store. Thereby, consistency and reliability of storage can be maintained while allowing a data object which genuinely needs to be deleted to be removed from the store.

Viewed from a first aspect, the present invention provides a backup system operable to store files or file segments using a single-instance storage schema. The backup system can comprise a metadata store operable to store metadata relating to a file, wherein each metadata store entry includes a fingerprint calculated from the file to which the entry relates and unique to the contents of that file. The backup system can also comprise a content store operable to store a file segment belonging to a file identified in a metadata store entry which segment can be identified using a fingerprint calculated from the segment and unique to the contents of that segment, and operable to store a data object describing a file identified in the metadata store and which can be identified using the unique fingerprint of a file which it describes. The data object can comprise a list containing the segment fingerprint of each segment of the file. The content store can be operable to carry out actions on segments and data objects stored therein in chronological order of receipt of instructions to perform those actions by a content store action queue. The backup system can be operable to identify a file for deletion, mark the metadata store entry for the file for deletion, to remove a reference to the metadata store entry for the file from the data object and to delete the marked metadata store entry from the metadata store. Thereby, a single-instance store can operate a reliable and safe data retention policy to safeguard stored data whilst also allowing data that need not be retained any longer to be deleted.

In some examples, each data object can describe more than one file and can be identified using the fingerprint of each file which it describes. Thus a single entity can be used for tracking the continued relevance to a plurality of source files of a files segment within a single-instance filesystem

In some examples the system can also, if as a result of the removal of a reference to a metadata store entry from a data object the data object no longer describes any file, delete the data object. Thus identifiers for no-longer required files can be removed completely from storage. In some examples the system can be operable to carry out the deletion of the data object by adding an instruction to delete the data object to the back of the content store action queue; hiding the data object; checking, when the instruction to delete reaches the front of the content store action queue, to determine whether the data object has been the subject of a write action since the instruction to delete was added to the instruction queue; and, if no such write action has occurred, deleting the data object. Thus the deletion of the data object can be carried out in such a manner as to ensure that an instruction relating to the data object after the data object is identified for deletion but before it is queued for deletion can prevent deletion of the data object to maintain full data integrity.

In some examples, following removal of the reference to the metadata store entry for the file from the data object, the system can remove from the data object the link to any segment no longer related to any file described in the data object. Thus a segment which is no longer required for any file identified in a data object can be unlinked from the data object to indicate the lack of relevance of that segment to that data object.

In some examples, the system can be operable, following removal from the data object of the segment link, to remove the segment if no data object now links to that segment. Thus a segment which is no longer linked to any data object and thus has no continued relevance to any file in storage, can be removed altogether. In some examples, removing the segment can be carried out by: adding an instruction to delete the segment to the back of the content store action queue; hiding the segment; checking, when the instruction to delete reaches the front of the content store action queue, to determine whether the segment has been the subject of a write action since the instruction to delete was added to the instruction queue; and if no such write action has occurred, deleting the segment. Thus the deletion of the segment can be carried out in such a manner as to ensure that an instruction relating to the segment after the segment is identified for deletion but before it is queued for deletion can prevent deletion of the segment to maintain full data integrity.

Viewed from a second aspect, the present invention can provide a method for deleting files or file segments from a storage system using a single-instance storage schema. The method can comprise: storing metadata relating to a file in a metadata store, wherein each metadata store entry includes a fingerprint calculated from the file to which the entry relates and unique for that file; storing in a content store a file segment belonging to a file identified in a metadata store entry, which segment can be identified using a fingerprint calculated from the segment and unique for that segment; and storing in the content store a data object describing a file identified in the metadata store and which can be identified using the unique fingerprint of a file which it describes and which data object comprises a list containing the segment fingerprint of each segment of the file. The method can further comprise causing instructions for actions on segments and data objects stored in the content store to be carried out in chronological order or receipt of the instructions to perform those actions; identifying a file for deletion; marking the metadata store entry for the file for deletion; removing a reference to the metadata store entry for the file from the data object; and deleting the marked metadata store entry from the metadata store.

Further aspects and embodiments of the invention will become apparent from the following description of various specific examples.

### BRIEF DESCRIPTION OF THE FIGURES

Particular embodiments of the present invention will now be described, by way of example only, with reference to the accompanying drawings in which like parts are identified by like reference numerals:

FIG. 1 shows a schematic representation of a distributed computing environment in which a data backup process may be used;

FIG. 2 shows a schematic representation of another distributed computing environment in which a data backup process may be used;

FIG. 3 shows a schematic representation of how a data file may be modified between two time points;

FIG. 4 shows a schematic representation of a single instancing backup system;

FIG. 5 shows a schematic representation of a data object;

FIG. 6 shows a flow chart of deleting a file;

FIG. 7 shows a flow chart of deleting a data object; and

FIG. 8 shows a flow chart of deleting a file segment.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### SPECIFIC DESCRIPTION

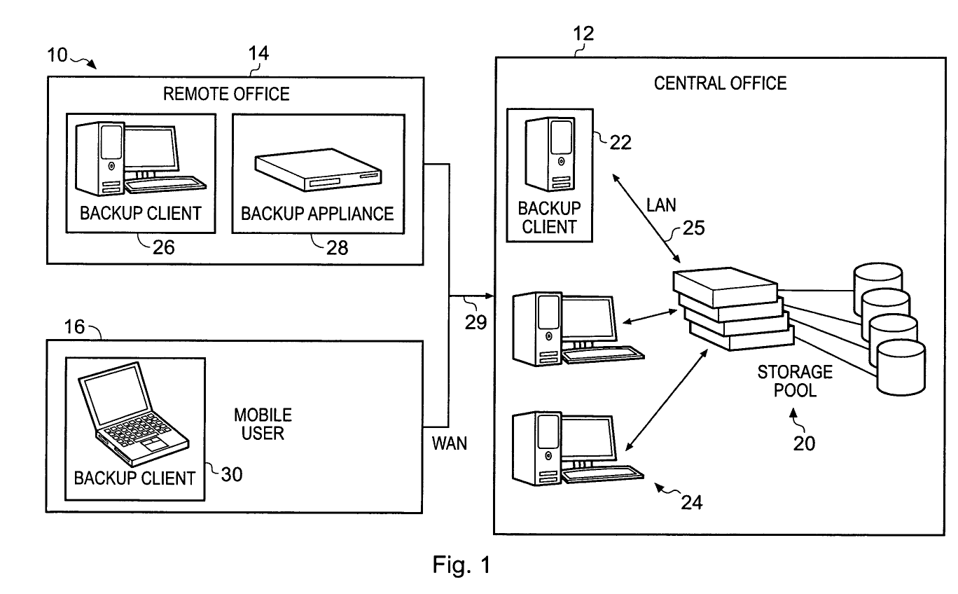

As shown in FIG. 1, a distributed computing environment 10 may include a central office 12, and may also include one or more remote offices 14 and/or one or more remote users 16. The central office 12 may include a storage pool 20 into which data may be backed up. Management of a backup process may be performed by a backup client 22 on behalf of one or more local workstations 24. Backup data can be passed to the storage pool 20 via a LAN (local area network) 25.

A remote office 14 may include one or more backup clients 26, which may be dedicated backup co-ordinators, or a backup client may be provided on workstation. By means of this backup client 26, data can be backed-up onto a remote office backup appliance 28. The backup appliance 28 can then transfer backup data to the storage pool 20 at the central office over WAN (wide area network) link 29.

A mobile user 16 may be provided with a backup client 30 to run on a remote terminal. This backup client 30 can send backup data to the storage pool 20 of the central office 12 via the WAN link 29.

In the present example, the amount of backup data to be transmitted over the LAN 25 and WAN 29 is limited by ensuring that only unique data is sent to the backup storage pool 20. Techniques for achieving this will be explained in more detail below.

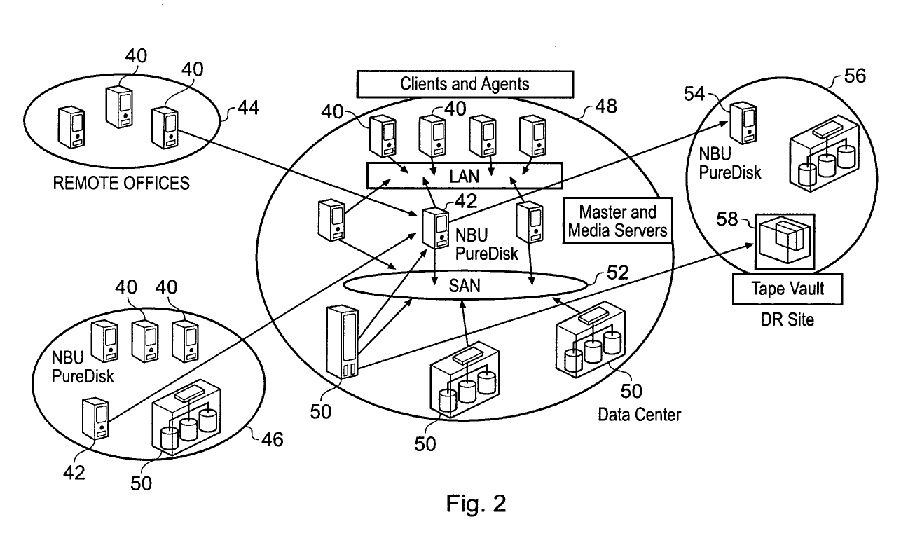

FIG. 2 shows another example implementation of a distributed computing environment. In this example, some workstations and mobile users are associated with respective local backup servers, each of which is operable to communicate with a data centre where backup storage is performed.

As shown in FIG. 2, in the present example, each computer system 40 which is to be included in the backup system runs a backup client, which may also be referred to as an agent. Each local agent identifies new and changed files or file segments as they are created and calculates a fingerprint for each file or file segment. The agents can be configured to ignore files which do not require backup such as, for example, print spool files, operating system file or temporary files.

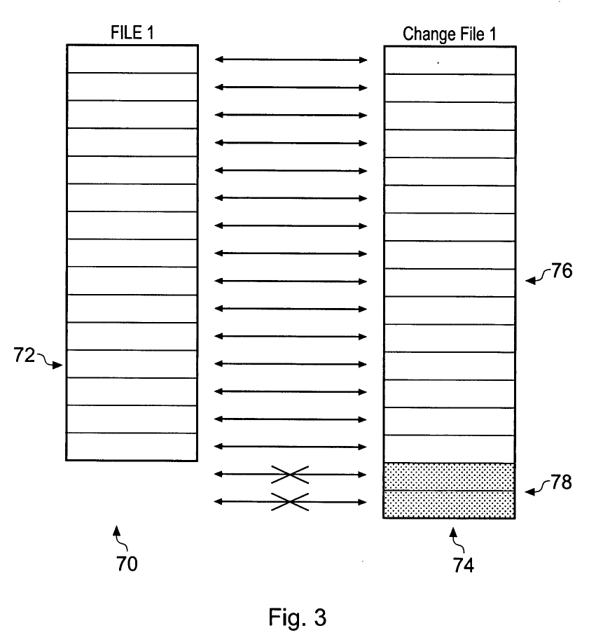

In the present example, files larger than a predetermined threshold are divided into segments. This allows large files to be backed up more efficiently. For example, a file such as an MSOutlook™.pst file typically contains a large amount of data which remains constant and has new data appended thereto when a user sends or receives an email or makes a calendar entry, for example. Thus, when a backup operation is performed in segmented fashion, all of the segments at the beginning of the file which are unchanged need not be backup up again. This process is illustrated in FIG. 3.

As shown in FIG. 3, a file 70 when last backed up was backed up as a number of backup segments 72. When a next backup operation is performed the file has increased in size to new file 74. During this backup operation, a backup agent again considers the file as a number of segments, each of which has a fingerprint calculated therefor. By comparing these fingerprints to the fingerprints included in previous backups, it can be determined that all of segments 76 have previously been backed-up and so do not require re-storing in a backup system. On the other hand, the new segments 78 have not previously been backed-up and so can be sent for backup storage. By using such a technique, the amount of data sent for backup storage on a backup operation can be reduced massively from a system where all changed files are sent for backup every time.

In the following description, the words file and segment may be used interchangeably to refer to backup data units. It will be appreciated that where a file is smaller than the predetermined segment size, the file can be considered to be segmented into a single segment. In the present examples, a variety of segment sizes can be used. As will be appreciated smaller segment sizes increase the efficiency of the backup process but increase the processing workload by the backup agent. In some examples, segment sizes of 32 kbytes, 64 kbytes or 128 kbytes can be used.

The fingerprint determined by the agent uniquely identifies the file or file segment by its contents. The fingerprint is unique for the contents of the file or file segment, which is to say unique for the data within that file or file segment. Two files with different names are typically considered as two different files by a user, but two such files can have exactly the same content (or partial content in the case of file segments). In that case, they will have the same fingerprint. Thus no two non-identical files or segments can have the same fingerprint, and identical files or segments always have the same fingerprint. In the present example, the fingerprint is calculated using a hash function. Hash functions are mathematical functions which can be used to determine a fixed length message digest or fingerprint from a data item of any almost size. A hash function is a one way function—it is not possible to reverse the process to recreate the original data from the fingerprint. Hash functions are relatively slow and expensive in terms of processing power required compared to other checksum techniques such as CRC (Cyclic Redundancy Check) methods. However hash functions have the advantage of producing a unique fingerprint for each unique data set, in contrast to CRC methods which can produce the same result from multiple different data sets. Examples of hash functions which can be used to calculate the fingerprint in the present example include MD5, SHA1 and SHA256.

The agent at each workstation 40 then identifies the files or segments which are new and unique to that workstation. Thus, if a newly created file or segment at the workstation in fact is an exact copy of a file or segment previously backed-up, then the agent knows not to send that segment for backup again.

Once the agent has identified a unique segment at the workstation 40, the fingerprint for that segment can be sent to a backup server 42, where its uniqueness can again be tested. This re-test is performed to determine whether the file which is unique to a particular workstation 40 is also unique to all workstations which that backup server 42 services. The backup server may be a local backup server as shown in remote office 46 or as shown in central network 48 with respect to the workstations 40 located within the central network 48. Alternatively, the backup server may be a remote backup server as shown in central network 48 with respect to the workstations 40 located at remote office 44. Where a workstation 40 is a mobile workstation such as a laptop, the backup agent on the mobile workstation may be configured always to connect to the same backup server, or may connect to whichever backup server is physically closest to the mobile workstation at a given time.

This process of sending a fingerprint to a higher level authority within the backup structure can be continued until the highest level authority is reached. In a large system, this might be a central backup server to which a number of local backup servers are connected. In a small system, there might be only a single backup server to service all workstations. If the segment is determined to be unique within the backup system, the originating workstation agent can be instructed to send the actual data segment for backup.

Segments which are not unique may also have their fingerprint sent to a backup server by a backup agent. This may be the case in a system where a data retention policy is defined, to ensure that a file or segment is maintained in backup storage for a minimum period after the last time it was present on any workstation within the backup environment. In some examples it may also be necessary to ensure that all segments of a given file are present in the backup system until the expiry of a data retention requirement for that file. Thus all segments of a file may need to be kept until the end of a data retention policy period, not just the last modified segments thereof.

It will be appreciated that the workstations 40 of the present example may include file or application servers where data requiring backup is stored. For example, it may be the case that file servers are used to store many data files, so the content of these may be required to be backed up. In the example of an application server such as a MSExchange™ server, the application server may store data relating to the application and may therefore require backup. Also application files. whether located at a workstation or a server, may require backup coverage, for example to provide a straightforward method for recovery of custom settings or rebuilding of a workstation or server following a system failure.

As mentioned above, a data retention policy may apply to data within a computer system. Such a policy may be a policy determined by a company or may be imposed by a regulatory authority. Regulator imposed policies may apply, for example in respect of financial information and legal information. For this reason, it may be desirable for a workstation backup agent to include deleted files in the backup operation to ensure that a file with an existence on a workstation of less than one backup interval is still included in the backup process.

As will be appreciated, by performing the backup process in terms of using a fingerprint typically of the order of a few tens of bits in size to determine which segments actually need backing up, the amount of data transferred over network connections between the workstations and backup servers is much reduced compared to a system where data identified for backup is sent for storage before it is determined whether storage of that data is actually required.

Returning to FIG. 2, the backup servers 42 may cause the data for backup to be stored into a storage arrangement such as a storage server 50. The storage servers 50 may be standalone storage servers or may be part of a storage infrastructure such as a SAN (storage area network) 52. In alternative examples the backup server 42 may include the storage for backed up data.

To provide redundancy and greater security and availability for backed up data, a storage server 42 may consist of a mirrored pair of storage servers, with one active and the other acting as a hot standby, ready to take over in case of a failure of the active backup server. A remote mirror 54 may be provided, for example at a remote site 56, to provide resiliency against failures affecting the location of the active backup server. Such a remote site may also be used to make and/or keep backup copies of the backed up data, for example in backup magnetic arrangements or using conventional backup techniques such as a tape vault 58.

Thus there has been described a number of examples of a backup environment for using data fingerprints to identify files and/or segments for backup and to backup only unique files and segments so as to achieve maximum efficiency in usage of backup storage volume.

In order to provide a means for accessing the files and segments in the backup system, the files and segments can be stored in an indexed file system or database structure which allows a file or segment to be identified and retrieved by a search on its fingerprint. The fingerprint may also be considered as a “signature” of the file or segment. Thereby a simple file system or database structure can be used for the files and segments, thereby allowing a swift search and retrieval process.

In order to facilitate searching the contents of a backup store of the type described above, both to assess the contents of the store, and to retrieve data from the store, a database of metadata can be provided. The database of metadata or “metabase” can store data describing each file stored into the backup system. Such data may include information such as filename, last edited date, created date, author, file size and keywords representative of the content of the file. Also stored in the metabase can be the fingerprint (or fingerprints) for the file (or each segment of the file). Thereby, a user searching the metabase for files edited on a particular date can run a query on the metabase, and any returned results can enable the files in the backup system to be retrieved by means of their uniquely identifying fingerprint. A system constructed in this way enables the metabase to have a high speed search performance due to the database size being small compared to the actual backed up file sizes, and allows a simple search procedure to be used for the file/segment database.

In another example, the file/segment and metadata databases are combined into a single database. Such a system offers a simplified structure in the sense that only a single database is required.

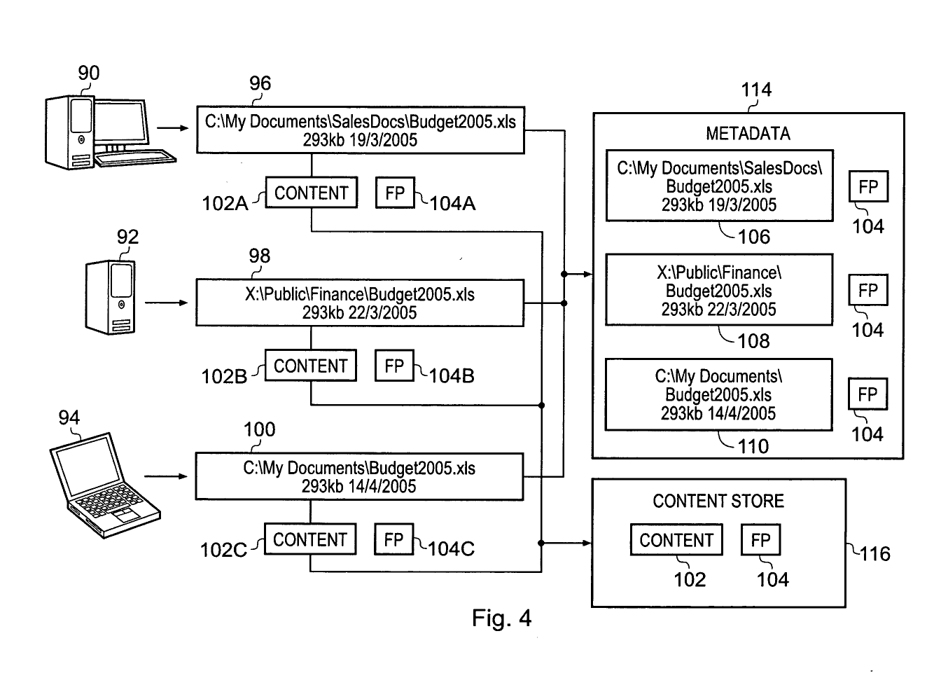

Returning to the separate metabase and file/segment store example, this system can be run as a single instancing store by allowing more than one entry in the metabase to include the same fingerprint. This is illustrated in FIG. 4.

In each of the three computer devices: terminal 90, file server 92 and mobile terminal 94, an identical spreadsheet file “Budget2005.xls” is stored. At the terminal 90, the file 96 was stored in the “C:\My Documents\SalesDocs” folder on 19 Mar. 2005 having a size of 293 kB. At the file server 92, the file 98 was stored in the “X:\Public\Finance” folder on 22 Mar. 2005 having a size of 293 kB. At the mobile terminal 94 the file 100 was stored in the “C:\My Dcouments” folder on 14 Apr. 2005 having a size of 293 kB. As the files 96, 98, 100 are identical, they are all the same size, have the same content (102A, 102B, 102C respectively) and result in the same fingerprint FP (104A, 104B, 104C) being generated at a backup operation time.

Backup operations on each of the terminal 90, file server 92 and mobile terminal 94 may be carried out at different times, with the results of the backup of each being added into the backup system at the respective different times. For example, a backup operation for the mobile terminal 94 may be carried out at a time different to the backup operation for the terminal 90 or file server 92 if the mobile terminal 94 is remains unconnected to the backup system for a period of time during which a scheduled backup operation took place for the terminal 90 and file server 92.

For the performance of a backup operation for the terminal 90, the fingerprint 104A is calculated for the file 96, which fingerprint 104A is compared to the content store part 116 of the backup system. If the fingerprint is unique in the backup system, then the content 102A of the file 96 needs to be stored into the content store 116, shown as content 102 associated with fingerprint 104. If the fingerprint is not unique in the content store (i.e. if that file has previously been backed-up), then the content need not be stored again. In parallel with determining whether the content 104A needs to be stored, metadata 106 for the file 96 is stored into the metabase 114 if the file 96 has not previously been backed-up. The metadata 106 is stored in association with the fingerprint 104 which identifies the content 102 stored in the content store 116.

Similar processes are carried out when the file 98 on file server 92 and the file 100 on mobile terminal 100 are selected for backup. Thus, once the files 96, 98, 100 have each been included in a backup process, the metabase contains and entry for each of the files, as each has different metadata, but the content store has only a single copy of the file. In an alternative implementation, the metabase could have a single record for each fingerprint, with the record storing the metadata for all original instances of the file which generated the fingerprint.

Thereby, a metabase containing metadata for all original instances of a file can be provided to provide a searchable environment for retrieving files/segments stored in the content store. Meanwhile the content store contains only one instance of each file/segment, so as to limit the storage space required by the content store. The metabase records are linked to the content records in the content store by the fingerprint for each respective content record.

To aid with management of files and segments within the content store, a data object entity can be introduced. The data object can facilitate management of segments within a file without a large number of segment links being needed for each metabase entry. Also, the data objects can allow files to be grouped within the backup system.

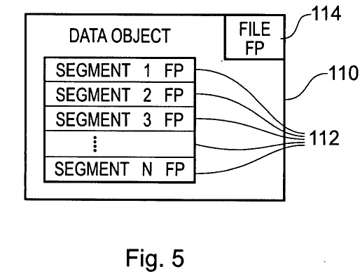

With reference to FIG. 5, there is shown a data object 110. The data object links the original file with all of its segments by providing a list 112 of all segments which constitute that file. The data object 110 can be stored within the content store along with the segments. In order to be able to identify and access the data object within the store, it can be associated with the fingerprint of the original file taken as a whole. In the case of single segment files, the system of the present example creates a segment object for the segment (because other, multi-segment files may contain this segment as one of their segments). The system also creates a data object but in this case the segment list in the file object contains only one segment. Both the file and the segment object have (and are stored under) the same fingerprint. Through the data object 110, the original file can be reconstructed by retrieving the segments 112 referred to in the data object 110 and appending them one after the other in the order in which they appear in the data object.

For each segment, a list of the data objects with which it is associated can be stored in the content store with the segment. The data object list is stored as an addendum or metadata to the segment and is not considered part of the segment. Thus the segment fingerprint is not altered by the data object list. The data object list of a segment is effectively bookkeeping information for the segment and is not seen as part of the segment data. Since the segment fingerprint is computed solely over the segment data, the segment fingerprint is independent of any segment bookkeeping information like the data object list.

This provides the linking of segments to files. It has been described above that unique segments are stored only once in the content store to avoid unnecessary duplication of segments in the file store. As described above, it is necessary to actively perform such single instance processing as, in practice, two files can be different but still have one or more segments in common. Such a common segment is stored once, but the two files will have different data objects that are both stored in the content store. Both data objects will thus refer to the common segment(s). To provide a way of linking a segment to all the data objects that refer to it (and hence to all the files that contain the segment), a list of these data objects is recorded for each segment. This list thus contains the data object references of the segment.

Thus, during backup operations, when a backup client wants to backup a segment (as part of a file backup), it will query the content store to verify it this segment is already present on the content store. If the content store responds affirmatively to this query, the client requests the content store to add a link from the segment to the data object corresponding to the file the client is backing up, rather then sending the actual segment to the content store.

In order to complete the circle of relationships between the various parts and descriptors for a file, links are provided between the file metadata records in the metabase and the data objects in the content store. In its simplest form, this can be realized by including the file fingerprint in the metadata record and, vice versa, by including a link to the metadata record in the data object. In some examples, it may be desirable to group files according to a certain criterion. Examples of grouping criteria are: the backup date (e.g. group all files backed up on the same day) or the source of the backup (e.g. group all files backed up from the same computer appliance or all files belonging to a particular user or group of users). In the remainder of this description this general example will be assumed, and a user-defined group of files will be called a file group. Under this assumption, the link from a metadata record to the corresponding data object is still provided through the file fingerprint. However, in addition, a data object can be linked to the metadata records referring to that data object by recording, together with the data object, the file group or groups holding one or more of said metadata records. For example, assuming three file groups exist, where file group 1 holds two metadata records referring to data object X, file group 2 holds 1 metadata record referring to data object X and file group 3 holds no metadata record referring to data object X, then the list of file group links recorded on the content store for data object X contains the group identifications 1 and 2. Using links to file groups instead of links to individual metadata records provides that the number of links recorded for a data object can be limited. During backup operations, when a client is backing up files for a file group 1, the client will request the content store to link each backed up data object to file group 1, regardless whether the data object was already stored on the content store or was effectively stored by this client.

Thus there has now been described a system for providing a content optimised backup and/or archival solution for data networks. The system ensures that all unique data is stored whilst avoiding unnecessary storage of non-unique data. By analysing large data objects in segments, this optimisation is further enhanced.

As is clear from FIG. 4, a given content item can have links to multiple entries in the metadata store (or “metabase”). In some examples, it is clear that any given content item could have links to one, a few or many metabase items. For example, a document may be authored by a single person before being supplied to a recipient outside the entity in which it is created. Thus this would probably have only a single metabase entry per content store entry. In another example, a document may be co-authored by a small team, or may be created by one person and emailed to other team members. In such a situation, a content item may be expected to have a few metabase entries per content store entry. In other examples, a document may be created by a single individual and then copied to many or all persons within an organisation or division. In this example, each content item may have hundreds or even thousands of metabase entries for each content store entry.

If a segmentation scheme is applied to this, the situation could become even more extreme. Taking the example of a document being distributed to an entire organisation or division, if the document is a large document it may contain many segments. Next, assume that the document is one which will be sent on from some of the recipients to individuals outside the organisation. Also, the original document contains a few spelling mistakes. Some of the recipients will correct none of the spelling mistakes before forwarding, some will correct a subset of the mistakes, some will correct all of the mistakes, and others will correct other subsets of the mistakes. This will result in the copies maintained by some users being identical to the original, and the copies maintained by other users being modified from the original in some way. Thus the segmentation of the altered documents may create new segments which also need to be stored. Due to the nature of the amendments made by the different users, multiple users may independently create identical files or have files which create identical segments. Therefore, from the one original document there become potentially many similar and related segments, each linked to different groups of users via many different metabase entries. If the various changes are made by the various users over a timescale of a few months or years, the web of segments and metabase entries can become even more tangled.

Thus, if it is desired to remove data from the content store, for example after expiry of a data retention period defined in a data retention policy, it can be difficult to determine which content store entries and metabase entries can be safely deleted whilst leaving later versions of a document intact and retrievable.

Also, it can be difficult to determine a definitive state of the database at any given time. For example, a given content store item is due to be deleted as a predetermined threshold time has been reached since the item was last identified as present on a source computer served by the archival/backup system. Thus, the item is deleted. However, immediately before the item is deleted, a query is received from a backup agent asking whether a segment having a fingerprint matching that of the now-deleted item is present in the store. As the item is, at that time still present, the backup agent received a positive reply and therefore does not send the segment for storage. However, immediately after the query being responded to, the item is deleted under the data retention schema. Thus data may be lost inadvertently.

This situation can be addressed by implementing a data removal policy designed to avoid the possibility of such a situation occurring. Such a system will now be described in greater detail.

In the following description, it is assumed that the data object entity described above with reference to FIG. 5 is implemented within the backup system. It is also assumed that the content store uses a serialized action queue for received action instructions. These two features of the backup system can be utilised to enable data removal without allowing accidental data loss.

In the present examples, a queue mechanism is implemented to serialize the actions performed on the content store. All actions on the content store are added to this queue and executed on a first-come, first-served basis, and no action is allowed to bypass the queue. Examples of possible actions are: store a new segment, store a new data object, add a link from an existing segment to a new data object, add a link from an existing data object to a file group, remove a link from a data object to a file group, remove a link from a segment to a data object, remove a data object, remove a segment. It should be noted that certain queries and subsequent actions from backup clients must be atomic operations. For example, when a backup client asks the content store if a particular segment is already present on the store, and subsequently (after receiving a positive reply) requests a link action for that segment, it must be ensured that no other action can enter the queue between the query and the action request. Otherwise, data may be lost inadvertently, as already explained above.

With the provision of the data objects and the use of serialized actions queue as described above, the data removal process can proceed as explained below. The process consists of two main phases, with the first phase being processed at the metabase and the second phase taking place on the content store.

The process is initiated on the metabase starting with a list of files to be removed The list can contain any number of files in the range of a single file to all of the files in the store. The list can be determined according to data retention and expiration policies, for example all data older than a certain age (perhaps an age specified in legislation or regulations governing data retention) may be identified for removal.

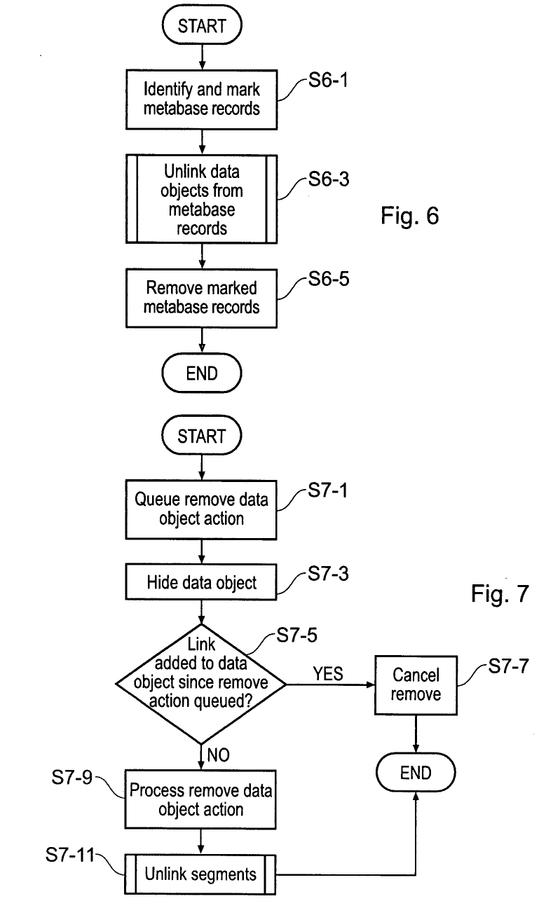

The method is illustrated in FIG. 6. First, at step S6-1, the metadata records for the files to be removed are identified in the metabase and are marked as expired in the metabase. As soon as a record is marked as expired, a backup client can no longer use it as an entry point to retrieve the file to which it refers. Next, at step S6-3, the metabase requests the content store to unlink the data objects from the metabase records that are marked as expired. In an example where each data object refers to a single file, this is a matter of performing the one-to-one unlink between those records. In a more general example as discussed above, this step is more complicated because data objects are linked to file groups and not directly to metadata records, such that there may not be a one-to-one relationship between metadata records and data objects. Thus, when (the metadata record of) a file A belonging to a file group 1 is expired, this does not immediately indicate that the link to file group 1 on the corresponding data object can be removed. Indeed it is conceivable that within file group 1, a second file called file B exists which has the same fingerprint as at least one fingerprint of file A and hence refers to the same data object on the content store as file A. In such a case, the link to file group 1 on said data object must not be removed. As a general rule, the metabase is allowed to unlink a certain data object from a file group if and only if all metadata records, within the file group, that refer to that same data object are marked as expired. Once this condition is met, such that the file group has no more references to the considered data object can the link effectively be removed.

Once the data objects have been updated as required, the expired metadata records can safely be removed from the metabase at step S6-5. In one example, this removal can be completed immediately. In another example, the expired records may be kept in the metabase for a further period of time. This may serve the purpose of allowing a history to be kept or allowing tracking, in this example, removal may take place after a predetermined further time has elapsed.

In step S6-3, the content store processes the unlink actions requested by the metabase. The unlink data object actions are all placed in the content store queue and are processed in the order in which they entered the queue. Each unlink action removes a file group from the list of file groups attached to a data object. As a result, the data object is no longer part of the file group.

In a particular case, the unlink action may remove the last file group link from a data object. This is an indication that the data object is no longer needed by any file group and can therefore be deleted, unless the action queue still contains a link request from a client for this particular data object. If such action were to exist, data loss could occur if the data object were to be removed immediately. The process to avoid such data loss is shown in more detail in FIG. 7. Therefore, in the present example, the data object is not removed immediately but instead an action to remove the data object is added to the content store queue at step S7-1. At the same time, the content store makes the data object inaccessible or otherwise hides the existence of the data object at step S7-3. The first-in-first-out operation of the content store queue thus ensures that any action which adds a link to the considered data object will already have been processed by the time the remove action is ready to be processed. Moreover, no new link requests for the data object will have been added to the queue as the data object has been unavailable since the remove action was added to the queue. Indeed, when a backup client requests the store to add a link to this data object, the content store will respond that it does not hold the data object yet, and the client is then forced to request the content store to create a new data object.

Thus, when the content store is ready to process the remove action, any action that adds a link to the data object is already processed and no new such actions are pending in the queue. Consequently, before processing the remove action, the content store verifies at step S7-5 whether any link has been added to the data object. If yes, the remove action is cancelled at step S7-7 (since the data object is still in use), otherwise the remove action is processed at step S7-9.

When processing a data object remove action (as in step S7-9), the content store removes the data object. When a data object is removed, the links from that data object's segments to the data object are no longer necessary and can be removed at step S7-11. Hence, for each of these segments, the content store adds an unlink action to its queue. These actions are added to the queue (as opposed to being executed immediately) to allow any action already scheduled for one of the involved segments to be processed first. When such unlink action is processed, the segment is no longer linked to the data object.

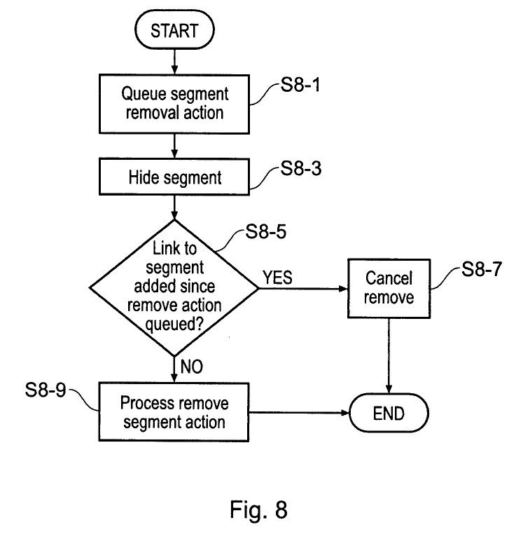

Similarly to the data object unlink actions, there are cases where a segment unlink action may remove the last data object link from a segment. This is an indication that the segment is no longer needed by any data object and can be deleted, unless the action queue were still to contain a link request from a client for this particular segment. If such action were to exist, removing the segment immediately would result in data loss. The presence of the link action would mean in fact that a client intended to backup the segment, but was told by the content store that the segment already exists, such that a link action was placed in the queue instead. Once this action is in the queue, the client trusts that the segment is effectively stored and preserved. Hence, returning to the earlier statement, removing a segment immediately after removing the last link on that segment could result in data loss. The process to avoid such data loss is detailed in FIG. 8. Therefore, the segment is not removed immediately, but instead a segment removal action is added to the content store queue at step S8-1, and the content store hides the segment to the outside world (in fact, to the backup clients) at step S8-3. When this segment removal action reaches the end of the queue and is ready to be processed, any other action involving this segment that was in the queue has been processed, and no new actions for this segment can have been added to the queue. Thus, when the content store is ready to process the segment removal action, it verifies whether any link has been added to the segment at steps S8-5. If yes, then the removal action is cancelled at step S8-7 as the segment is still needed, otherwise the removal action is processed at step S8-9.

As will be noted from the above description of the removal process, a data object which is removed from a file group is not actually deleted from the content store unless it is no longer referenced by any file group. Likewise, a stored segment is not actually deleted from the content store unless it is no longer linked to any data object. This is a result of the fact that the content store uses single instancing to maintain an efficient store size.

Thus a backup system which implements single instance storage of file segments to achieve an efficient storage space utilisation can be configured to allow deletion of files and segments according to a data retention scheme without a danger of data loss caused by delete and write instructions overlapping in time.

Many alterations, modifications and additions and their equivalents to the described examples will be apparent to the skilled reader of this specification and may be implemented without departing from the spirit and scope of the present invention.

1. A backup system operable to store files or file segments using a single-instance storage schema, the backup system comprising:
a metadata store operable to store metadata relating to a file, wherein each metadata store entry includes a fingerprint calculated from the file to which the entry relates and unique to that file; and
a content store operable to:
store a file segment belonging to a file identified in a metadata store entry, which segment can be identified using a fingerprint calculated from the segment and unique to that segment;
store a data object describing a file identified in the metadata store and which can be identified using the unique fingerprint of the file which it references and which data object comprises a list containing the segment fingerprint of each segment of the file; and
carry out actions on segments and data objects stored therein in chronological order or receipt of instructions to perform those actions by a content store action queue;
wherein the backup system is operable to identify a file for deletion, mark the metadata store entry for the file for deletion, remove a reference to the metadata store entry for the file from the data object and delete the marked metadata store entry from the metadata store.

2. The system of claim 1, wherein each data object can describe more than one file and can be identified using the fingerprint of each file which it describes.

3. The system of claim 2, wherein the system is operable to, if as a result of the removal of a reference to a metadata store entry from a data object, the data object no longer describes any file, delete the data object.

4. The system of claim 3, wherein the system is operable to: add an instruction to delete the data object to the back of the content store action queue; hide the data object; check, when the instruction to delete reaches the front of the content store action queue, to determine whether the data object has been the subject of a write action since the instruction to delete was added to the instruction queue; and if no such write action has occurred to delete the data object.

5. The system of claim 1, wherein the system is operable, following removal of the reference to the metadata store entry from the data object, to remove from the data object the link to any segment no longer related to any file described in the data object.

6. The system of claim 5, wherein the system is operable, following removal from the data object of the segment link, to remove the segment if no data object now links to that segment.

7. The system of claim 7, wherein the system is operable to: add an instruction to delete the segment to the back of the content store action queue; hide the segment; check, when the instruction to delete reaches the front of the content store action queue, to determine whether the segment has been the subject of a write action since the instruction to delete was added to the instruction queue; and if no such write action has occurred to delete the segment.

8. A method for deleting files or file segments from a storage system having a single-instance storage schema, the method comprising:
storing metadata relating to a file in a metadata store, wherein each metadata store entry includes a fingerprint calculated from the file to which the entry relates and unique to that file;
storing in a content store a file segment belonging to a file identified in a metadata store entry, which segment can be identified using a fingerprint calculated from the segment and unique to that segment;
storing in the content store a data object describing a file identified in a metadata store entry and which can be identified using the unique fingerprint of the file which it describes and which data object comprises a list containing the segment fingerprint of each segment of the file;
causing instructions for actions on segments and data objects stored in the content store to be carried out in chronological order or receipt of the instructions to perform those actions; and
identifying a file for deletion;
marking the metadata store entry for the file for deletion;
removing a reference to the metadata store entry for the file from the data object; and
deleting the marked metadata store entry from the metadata store.

9. The method of claim 8, wherein each data object can describe more than one file and can be identified using the fingerprint of each file which it describes.

10. The method of claim 9, further comprising:
if, as a result of the removal of a reference to a metadata store entry from a data object, the data object no longer describes any file, deleting the data object.

11. The method of claim 10, wherein the deleting of the data object comprises:
adding an instruction to delete the data object to the back of the content store action queue;
hiding the data object;
checking, when the instruction to delete reaches the front of the content store action queue, to determine whether the data object has been the subject of a write action since the instruction to delete was added to the instruction queue; and
if no such write action has occurred, deleting the data object.

12. The method of claim 8, further comprising:
following removal of the reference to the metadata store entry for the file from the data object, removing from the data object the link to any segment no longer related to any file referenced in the data object.

13. The method of claim 12, further comprising:
following removal from the data object of the segment link, removing the segment if no data object now links to that segment.

14. The method of claim 13, wherein the removing the segment comprises:
adding an instruction to delete the segment to the back of the content store action queue;
hiding the segment;
checking, when the instruction to delete reaches the front of the content store action queue, to determine whether the segment has been the subject of a write action since the instruction to delete was added to the instruction queue; and
if no such write action has occurred, deleting the segment.
